(19) United States
(12) Patent Application Publication
(10) Pub. No.: US 2024/0109215 A1
(43) Pub. Date: Apr. 4, 2024

(54) CUTTING UNIT FOR TUBULAR PRODUCTS AND APPARATUS FOR PRODUCING THEM

(71) Applicant: I.M.A. INDUSTRIA MACCHINE AUTOMATICHE S.P.A., OZZANO DELL'EMILIA (IT)

(72) Inventor: Fiorenzo DRAGHETTI, OZZANO DELL'EMILIA (IT)

(21) Appl. No.: 18/276,374

(22) PCT Filed: Jan. 28, 2022
(86) PCT No.: PCT/IT2022/050011

§ 371 Date: Aug. 8, 2023

(30) Foreign Application Priority Data
Feb. 22, 2021 (IT) IT102021000004022

(51) Int. Cl. B26D 1/58; B26D 3/16

(52) U.S. Cl. CPC B26D 1/585; B26D 3/16

(57) ABSTRACT

Apparatus for producing tubular products starting from a tubular body, wherein the apparatus comprises a cutting unit (10) disposed along a directrix of feed (A) of the tubular body to be cut, in order to obtain the tubular products. The cutting unit (10) comprises a rotating arm (11) mounted rotating around a first axis of rotation (R1), and at least one cutting member (12) mounted rotatable on the arm (11) in such a way as to rotate around a second axis of rotation (R2). The cutting member (12) is able to be moved toward a cutting position, in which the cutting member (12) interacts with the tubular body in order to cut it.

### FIELD OF THE INVENTION

The embodiments described here concern a cutting unit for tubular products and an apparatus for producing such tubular products. More specifically, the tubular products are straws, preferably made of recyclable material, for example paper or cardboard.

However, it is not excluded that the apparatus as above can be used for producing other tubular products made of biodegradable material, in particular of cellulose derivation, or similar and comparable materials or of different sizes, materials and applications.

### BACKGROUND OF THE INVENTION

Apparatuses for producing tubular products made of paper or cardboard are known, comprising at least one winding assembly in which one or more strips or paper filaments are wound in a spiral (“filament winding”) around a mandrel in order to make an oblong tubular body. In particular, the winding assembly can be used to manufacture tubular bodies by winding paper filaments under tension spirally around the mandrel with the provision of one or more intermediate layers of glue (“gluing” operation) to join the paper filaments together, giving them a suitable structural stability, as well as with an at least partial waterproofing function.

Furthermore, these known machines generally provide a cutting assembly, cooperating with the winding assembly, to cut the tubular body to size, obtained in such winding assembly, so as to produce tubular products of a desired length, such as for example paper straws.

These known cutting assemblies generally provide to cut the oblong tubular body while the wound paper filaments advance continuously in a direction of feed, and at the same time rotate around this direction of feed, which typically coincides with the longitudinal axis of the mandrel. Since the production of the tubular bodies takes place continuously, they are supplied with a continuous feed to the cutting assembly, and it is therefore necessary to carry out the cut while the tubular body is advancing along the axis of feed, in order to not affect productivity.

In particular, these known cutting assemblies are provided with a rotating blade in a position substantially tangent to the work axis and configured to cut the tubular body while it advances and rotates, that is, while it is roto-translating, along the axis of feed.

The roto-translation of the tubular body to be cut has to be coordinated with the movement and inclination of the rotating blade in order to ensure the correct cut of the tubular body.

Currently, known cutting assemblies carry out the cutting operation in correspondence with a terminal segment of the mandrel and often tubular products are obtained, in which the filaments can be partly chipped or frayed, due to an unclean cut, or with “flashes”, where the cutting section may not be regular.

These critical issues are most felt in the production of paper straws.

Cutting assemblies with a rotating blade are configured to move the rotating blade, while it rotates around its own axis of rotation, in a longitudinal plane, typically vertical, which contains the direction of feed of the tubular body, so as to accompany it during the cutting step. This determines a prolonged interaction between the tubular body and the rotating blade, which can cause the “flashes” of the cut.

There are also cutting assemblies which provide an arm rotating in a plane transverse to the direction of feed of the tubular body, and equipped at one end with a fixed blade which performs a punctual cut of the tubular body, passing through it transversely, or more advantageously, perpendicularly.

However, even these cutting assemblies with fixed blade do not allow to obtain a precise and clean cut of the tubular body. Furthermore, the fixed blade also entails the disadvantage of requiring sharpening with each rotation of the rotating arm, which causes it to wear out prematurely with the need to frequently replace the blades.

Another cutting assembly known in the state of the art is described in U.S. Pat. No. 4,041,813 A. This cutting assembly is configured to cut rolls of toilet paper or absorbent paper to size, and comprises a very complex mechanism to adjust the inclination of the cutting blade. This mechanism comprises numerous toothed wheels, some organized so as to define an epicycloidal system of a known type, and a plurality of motion transmission members between the various mechanical components.

The cutting assembly described by U.S. Pat. No. 4,041,813 A is bulky, expensive and very complex to adjust and maintain, thus requiring the frequent presence of a specialized operator to ensure correct functioning over time. Furthermore, this assembly is designed to cut to size tubular bodies with large diameters, in the order of magnitude of a decimeter or even more. Such an assembly would not be able to make a precise and flash-free cut of a tubular body, advancing at high speeds, such as straws, having a diameter that is at least two orders of magnitude less than that of the tubular bodies cut by the cutting assembly described by U.S. Pat. No. 4,041,813 A.

There is therefore a need to perfect an apparatus for producing tubular products which can overcome at least one of the disadvantages of the state of the art.

In particular, one purpose of the present invention is to provide an apparatus for producing tubular products which is able to make a precise and clean cut, that is, clean and without flashes, of the advancing tubular body.

Another purpose of the present invention is to provide an apparatus for producing tubular products which does not entail excessive wear of the blade and of the other moving components.

Another purpose of the present invention is to provide an apparatus for producing tubular products which is very simple from a mechanical point of view compared with the solutions known in the state of the art, which is thus less bulky and expensive; the maintenance operations are also less complicated and less frequent, so as to determine less downtimes of the machine.

Another purpose of the present invention is to provide a cutting unit for producing tubular products from a tubular body which is simple, effective and reliable.

The Applicant has devised, tested and embodied the present invention to overcome the shortcomings of the state of the art and to obtain these and other purposes and advantages.

### SUMMARY OF THE INVENTION

The present invention is set forth and characterized in the independent claim. The dependent claims describe other characteristics of the present invention or variants to the main inventive idea.

In accordance with the above purposes, hereafter we describe an apparatus for producing tubular products which overcomes the limits of the state of the art and eliminates the defects present therein.

In accordance with some embodiments, there is provided an apparatus for producing tubular products starting from a tubular body, comprising a cutting unit disposed along a directrix of feed of the tubular body to be cut, in order to obtain the tubular products.

The cutting unit comprises a rotating arm mounted rotating around a first axis of rotation which is inclined by an angle with respect to the directrix of feed, and on which there is mounted at least one cutting member provided with a cutting blade to cut the tubular body in a cutting position while the tubular body advances along the directrix of feed and while the rotating arm rotates.

The cutting member is driven in rotation by motion transmission means around a second axis of rotation which is inclined with respect to the first axis of rotation.

The motion transmission means comprise a motorized member, driven in rotation around a fourth axis of rotation, and a driven member, driven in rotation around a fifth axis of rotation by the motorized member through a motion transmission element.

The driven member is integrally coupled to the cutting member in such a way that the fifth axis of rotation is disposed so as to coincide with the second axis of rotation.

The relative disposition between motorized member and driven member, with which the cutting member is integral, allows the latter to gradually approach the tubular body to be cut tracking it for a segment of its feed, and thus obtain a straight and clean cut. This entails the fact that the arm rotating around the first axis of rotation, and consequently the cutting member, are inclined, or skewed, with respect to the directrix of feed.

In this way, the disposition of the cutting member allows to compensate for the inclination of the rotating arm that rotatably supports it, in such a way that in the cutting position the blade of the cutting member presents itself transversely to the tubular body, in particular perpendicularly to it, at the same time allowing the latter to be tracked in a direction parallel to the direction of feed, even during the cutting operation.

In particular, such angle and the disposition in space of the first and second axes of rotation are selected in such a way that the rotating cutting member, while cutting, follows a trajectory that allows to track, for a segment, the movement of the tubular body along the directrix of feed. Thanks to this configuration, the cutting member follows a hybrid movement of doubly inclined rotation which causes the fifth axis of rotation, in particular in proximity to the cutting position, to follow a trajectory that allows the cutting blade to cut the tubular body perpendicularly, while the cutting member advances longitudinally along the directrix of feed in a manner correlated with the feed of the tubular body during cutting. It has been found that this makes the cut even more precise and cleaner.

Furthermore, another advantage is that the cutting member, oriented as described above, is made to rotate by very simple and economical motion transmission means.

The trajectory can be a compound trajectory, comprising at least one axial component, which is substantially parallel to the directrix of feed, and one tangential component, which is locally oriented tangentially with respect to the cutting blade, and perpendicular to the axial component as above.

According to one aspect of the present invention, the angle is comprised between 2° and 45°.

According to one aspect of the present invention, the second axis of rotation is parallel to the directrix of feed when the cutting member is in the cutting position.

According to another aspect of the present invention, the directrix of feed and at least one of either the first axis of rotation or the second axis of rotation is horizontal when the cutting member is in the cutting position.

According to another aspect of the present invention, the cutting member and the driven member are mounted on a common support, in turn mounted on one end of the rotating arm.

According to another aspect of the present invention, the common support is mounted fixed to the rotating arm. It should be noted that in an initial set-up phase it is possible to adjust the position of the common support with respect to the rotating arm so as to vary the position of the driven member and of the cutting member, thus modifying the inclination of the second and fifth axes of rotation with respect to the directrix of feed. Once the common support has been positioned with respect to the rotating arm in the set-up phase, this position remains fixed during a subsequent operation.

According to another aspect of the present invention, the motorized member and the driven member each comprise a respective pulley.

According to another aspect of the present invention, the motion transmission element is a flexible member selected from a rope, cord, cable, belt or suchlike, which is configured to be disposed according to a twisted configuration as a function of the position of the motorized member and of the driven member.

According to another aspect of the present invention, the motorized member is mounted on the rotating arm.

According to another aspect of the present invention, the fourth axis of rotation is parallel to the first axis of rotation, preferably coaxial thereto.

According to another aspect of the present invention, the cutting unit also comprises a second rotating cutting member, which is mounted rotatable around a third axis of rotation on a second end of the rotating arm.

According to another aspect of the present invention, the cutting unit comprises another driven member, driven in rotation around another axis of rotation by the motorized member through another motion transmission element.

This other driven member is integrally coupled to the second cutting member, with the other axis of rotation disposed in such a way as to coincide with the third axis of rotation.

According to another aspect of the present invention, the first and second cutting members are symmetrical with respect to the first axis of rotation so as to have the same orientation with respect to the directrix of feed when they reach the cutting position.

According to one aspect of the present invention, there is also provided a cutting unit for an apparatus for producing tubular products starting from a tubular body and configured to be disposed along a directrix of feed of the tubular body to be cut. The cutting unit comprises an arm mounted rotating around a first axis of rotation which is inclined by an angle with respect to the directrix of feed, and on which there is mounted rotatable at least one cutting member provided with a cutting blade to cut the tubular body in a cutting position while the tubular body advances along the directrix of feed and while the rotating arm rotates.

The cutting member is driven in rotation by motion transmission means around a second axis of rotation, which is inclined with respect to the first axis of rotation. The motion transmission means comprise a motorized member driven in rotation around a fourth axis of rotation and a driven member driven in rotation around a fifth axis of rotation by the motorized member through a motion transmission element. The driven member is integrally coupled to the cutting member, with the fifth axis of rotation disposed in such a way as to coincide with the second axis of rotation.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a perspective view of a first embodiment of a cutting unit comprised in the apparatus according to the present invention;

FIGS. 2 and 3 are respectively a lateral view and a plan view of the cutting unit of FIG. 1; and

FIG. 4 is a perspective view of a second embodiment of a cutting unit of the apparatus according to the present invention.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

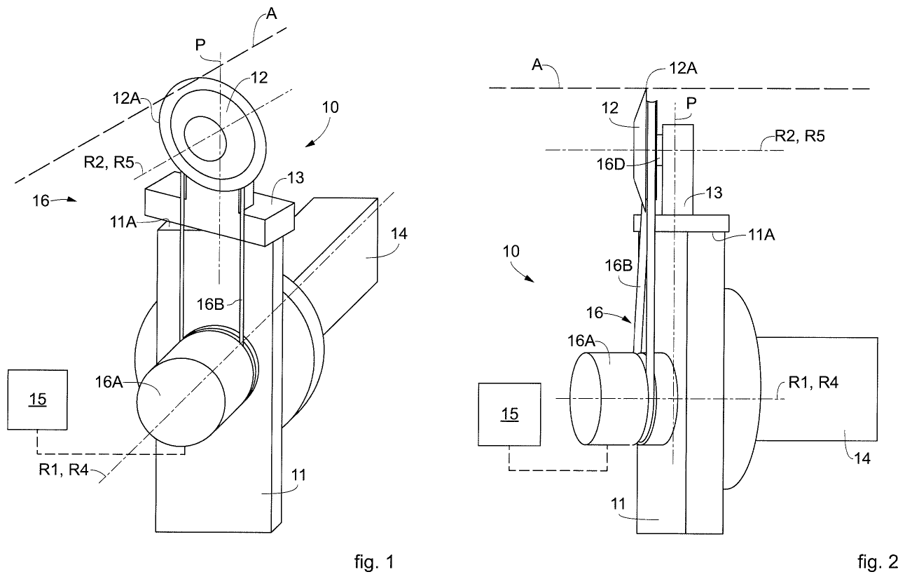

FIGS. 1-3 show a cutting unit 10, in particular for an apparatus for producing tubular products not shown in the drawings. As previously stated, the tubular products to be produced are preferably straws, more preferably made of paper and/or cardboard and/or paper board.

The tubular products are obtained by cutting a tubular body fed along a feed line which defines a directrix of feed A, typically rectilinear.

The cutting unit 10 comprises a rotating arm 11 on which there is mounted a rotatable cutting member 12 provided with a cutting blade 12A. The arm 11 is able to rotate around a first axis of rotation R1, while the cutting member 12 is able to rotate around a second axis of rotation R2, distinct from the first axis of rotation R1. Preferably, the cutting member 12 is mounted at one end 11A of the arm 11 (FIG. 1).

Preferably, the cutting blade 12A is configured as a circular blade; however, it is possible to provide any type of known rotatable cutting blade whatsoever, as long as it is able to cut the tubular body.

The rotating arm 11 is set in motion by a first motor 14, comprised in the apparatus according to the invention, preferably connected directly to the rotating arm 11.

The rotation of the cutting member 12 is instead commanded by a second motor 15, connected to the cutting member 12 by means of motion transmission means, indicated as a whole with reference number 16.

The motion transmission means 16 comprise a motorized member 16A, preferably cylindrical, driven in rotation by the second motor 15 around a fourth axis of rotation R4, a driven member 16D, driven in rotation around a fifth axis of rotation R5, and a transmission element 16B which connects the motorized member 16A to the driven member 16D so as to make the latter rotate (FIGS. 1-3).

In particular, in the example shown in the drawings, the cutting member 12 and the driven member 16D are mounted on a common support 13, which in turn is mounted on one end 11A of the rotating arm 11, and the transmission element 16B is configured as a transmission belt.

The driven member 16D is integrally coupled to the cutting member 12, with the fifth axis of rotation R5 disposed in such a way as to coincide with the second axis of rotation R2.

The motorized member 16A is mounted on the rotating arm 11, more advantageously it is mounted in such a way that the fourth axis of rotation R4 is parallel to the first axis of rotation R1, in particular being coaxial to the first axis of rotation R1 (FIGS. 1 and 2).

The rotating arm 11 allows to cyclically take the cutting member 12 in correspondence with a cutting position in which the cutting blade 12A passes through the tubular body, effectively cutting it. It should be noted that in FIGS. 1-3 the cutting unit 10 is shown in the cutting position.

In the cutting position, the cutting member 12 remains fixed with respect to the rotating arm 11 during the rotation of the cutting member 12 to carry out the cutting operation. This entails a considerable simplification of the apparatus compared to the solutions known in the state of the art, without compromising the quality of the cut, since in the known solutions it is necessary to provide complicated mechanisms to modify the position of the cutting member with respect to the arm that supports it during the cutting, that is, between the beginning and the end of the interaction between the blade and the object to be cut. In the example provided here, however, the cutting member 12 can remain fixed with respect to the rotating arm 11, thanks to the fact that the products to be cut are preferably straws, that is, tubular products with a very small diameter, of the order of a few millimeters. On the contrary, because the solutions known in the state of the art have been designed to cut products with a larger diameter, such as rolls of toilet paper or absorbent paper, in such solutions the position of the cutting member with respect to the rotating arm has to necessarily be modified because—if its position remained fixed—it would not be able to cut a tubular product of such a diameter that is moving along a feed path.

In this cutting position, moreover, the directrix of feed A, the first axis of rotation R1 and the second axis of rotation R2 are substantially disposed one above the other, with the second axis of rotation R2 in an intermediate position between the first axis of rotation R1 and the directrix of feed A. As in the example shown in FIGS. 1-3, typically the directrix of feed A is horizontal, and the first axis of rotation R1 and the second axis of rotation R2 are at two respective heights below the directrix of feed, and substantially vertically aligned with each other. However, other orientations can be provided according to requirements.

It should be noted that, in accordance with an advantageous aspect of the invention, the cutting unit 10 is configured in such a way that the cutting member 12 has, at least in correspondence with the cutting position, a trajectory that is transverse with respect to the directrix of feed A, in order to act on a defined cutting plane. This trajectory can be obtained through a suitable orientation of the first axis of rotation R1 and/or of the second axis of rotation R2.

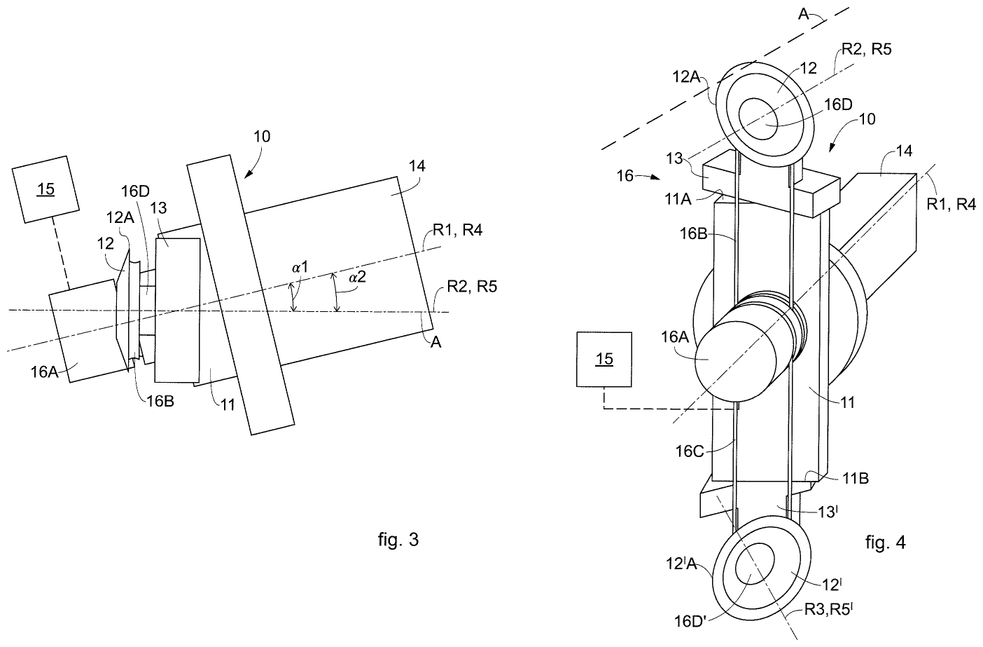

In accordance with some embodiments, the first axis of rotation R1 is inclined with respect to the directrix of feed A by a determinate angle α1, hereafter also referred to as first angle α1 (FIG. 3) for reasons of clarity. It can be provided that the first axis of rotation R1 is inclined vertically with respect to the directrix of feed A; however, it is preferable for the first axis of rotation R1 to also be horizontal.

Advantageously, the first angle α1 is smaller than 90°, preferably it is comprised between 1° and 80°, more preferably between 2° and 45°. In this way, there is guaranteed a movement of the cutting member 12 which is transverse to the directrix of feed A at least in correspondence with the cutting position.

The second axis of rotation R2 is inclined with respect to the first axis of rotation R1.

When the cutting member 12 is in the cutting position, the angle formed between the first and second axes of rotation takes on a value that we define second angle α2.

It should be noted that the angles as above are those measured between the orthogonal projections of the directrix of feed, of the first axis of rotation and of the second axis of rotation in a reference plane of the apparatus, for example on which it rests. Preferably, the reference plane is horizontal.

In order to ensure that the cut is made as perpendicular as possible with respect to the tubular body, the first and second angles α1, α2 have the same value, so that the inclination of the first axis of rotation R1 is fully compensated by the inclination of the second axis of rotation R2.

In the most advantageous variant, in addition to having the first and second angles α1, α2 equal to each other, the first and second axes of rotation R1, R2, as well as the directrix of feed A, are horizontal.

The result of this configuration is that, in the cutting position, since the inclination of the first axis of rotation R1 is compensated by the inclination of the second axis of rotation R2, the latter is parallel to the directrix of feed A.

This configuration ensures that during the cutting, the cutting blade 12A is perpendicular to the directrix of feed A, but it follows a trajectory which is not exactly perpendicular, rather slightly inclined with respect to the same directrix of feed A. This allows the blade to follow, for a short segment, the feed of the tubular body to be cut, which results in a sharper and cleaner cut than known solutions, and then—once the cut is finished—retract by the same distance that it advanced, in such a way as to follow a closed curvilinear trajectory.

In accordance with some embodiments, the inclination of the second axis of rotation R2 with respect to the first R1 is obtained by inclining the support 13 of the cutting member 12 with respect to the rotating arm 11 (FIGS. 1-3). The inclination is preferably performed in a perpendicular direction with respect to a longitudinal axis P of the support 13. This obviously implies that the cutting member 12 is mounted with the axis of rotation R2 perpendicular to the support 13.

Preferably, the longitudinal axis P of the support 13 is radial with respect to the first axis of rotation R1 (FIGS. 1 and 2) and can also coincide with the longitudinal axis of the rotating arm 11.

FIG. 4 shows a second embodiment of the cutting unit 10, which differs from the first embodiment of FIGS. 1-3 due to the presence of a second cutting member 12′ on the rotating arm 11. The second cutting member 12′ is mounted rotatable around a third axis of rotation R3 and comprises a cutting blade 12′A of its own.

Advantageously, the second cutting member 12′, which is preferably comparable to the first cutting member 12 (in this case, a circular blade), is mounted at a second end 11B of the rotating arm 11, opposite the first end 11A where the first cutting member 12 is positioned.

The second cutting member 12′ is preferably mounted on another driven member 16D′, comparable to the driven member 16D described above, and driven in rotation around another axis of rotation R5′. The second cutting member 12′ and the respective driven member 16D′ are mounted on a respective common support 13′, which in turn is mounted on the second end 11B of the rotating arm 11.

According to some embodiments, the third axis of rotation R3 is also inclined with respect to the first axis of rotation R1, so as to reproduce the configuration of the first cutting member 12, therefore the other axis of rotation R5′ is disposed in such a way as to coincide with the third axis of rotation R3.

Advantageously, the first and second cutting members 12, 12′ are disposed axially symmetrical with respect to the first axis of rotation R1. In this way, both cutting members 12, 12′, in particular the cutting blades 12A, 12′A, perform the same type of cut on the tubular body, which allows to increase the productivity of the apparatus for producing tubular products and obtain tubular products with identical ends.

Alternatively, it can be provided that the third axis of rotation R3 is inclined with respect to the first axis of rotation R1 by a different angle than the second axis of rotation R2. In this way, the first cutting member 12 performs a first type of cut on the tubular body, and the second cutting member 12′ performs a second type of cut, different from the first. The tubular products that can be obtained have two different ends, for example one cut perpendicularly to the axis of development of the product, the other inclined.

In any case, it is advantageous that the cutting members 12, 12′ are equidistant from the first axis of rotation R1. It is equally advantageous that the first axis of rotation R1 and the directrix of feed A are both horizontal.

In order to move or to rotate the second cutting member 12′, it can be provided to adapt the motion transmission means 16, for example by providing a second transmission element 16C that connects the motorized member 16A to the second cutting member 12′ (FIG. 4). By doing so, both cutting members 12, 12′ are moved by the same second motor 15, with the advantage of rotating at the same speed, for a greater uniformity of the cuttings of the tubular body.

The apparatus described heretofore, in particular with the cutting unit 10 as above, allows to move the cutting member 12 rotatable along a trajectory which, at least in correspondence with the cutting position, is transverse, or substantially perpendicular, with respect to the tubular body to be cut.

In particular, in the cutting position as above, the cutting member 12 is also transverse, more advantageously perpendicular, to the tubular body.

However, it is possible to provide a third motor member to move the second cutting member 12′ in an autonomous way.

It is clear that modifications and/or additions of parts or steps may be made to the apparatus and method to produce tubular products as described heretofore, without departing from the field and scope of the present invention as defined by the claims.

It is also clear that, although the present invention has been described with reference to one specific example, a person of skill in the art shall certainly be able to achieve many other equivalent forms of apparatuses for producing tubular products, all coming within the field of protection of the present invention defined by the claims.

In the following claims, the sole purpose of the references in brackets is to facilitate their reading and they must not be considered as restrictive factors with regard to the field of protection defined thereby.

1. Apparatus for producing tubular products starting from a tubular body, wherein said apparatus comprises a cutting unit disposed along a directrix of feed of said tubular body to be cut and having a rotating arm mounted rotating around a first axis of rotation that is inclined by a first angle with respect to said directrix of feed and on which there is mounted at least one cutting member provided with a cutting blade to cut said tubular body in a cutting position while said tubular body advances along said directrix of feed and while the rotating arm rotates, said at least one cutting member being driven in rotation by motion transmission means around a second axis of rotation which is inclined with respect to said first axis of rotation, wherein said motion transmission means comprise a motorized member, driven in rotation around a fourth axis of rotation, and a driven member, driven in rotation around a fifth axis of rotation by said motorized member through a motion transmission element, characterized in that said driven member is integrally coupled to said cutting member with the fifth axis of rotation disposed in such a way as to coincide with the second axis of rotation.

2. Apparatus as in claim 1, wherein said angle and the spatial disposition of said first and second axes of rotation are selected so that said at least one cutting member, while cutting, follows a trajectory which allows to track, for a segment, the movement of said tubular body along said directrix of feed.

3. Apparatus as in claim 1, wherein said angle is comprised between 2° and 45°.

4. Apparatus as in claim 1, wherein said second axis of rotation is parallel to said directrix of feed when said cutting member is in said cutting position.

5. Apparatus as in claim 1, wherein said directrix of feed and at least one of either said first axis of rotation or said second axis of rotation is horizontal when said cutting member is in said cutting position.

6. Apparatus as in claim 1, wherein said cutting member and said driven member are mounted on a common support which in turn is mounted on one end of said rotating arm.

7. Apparatus as in claim 1, wherein said common support is mounted fixed to said rotating arm.

8. Apparatus as in claim 1, wherein said motorized member and said driven member each comprise a respective pulley, and in that said motion transmission element is a flexible member selected from a rope, cord, cable, belt or suchlike, which is configured to be disposed according to a twisted configuration, as a function of the position of said motorized member and of said driven member.

9. Apparatus as in claim 1, wherein said motorized member is mounted on the rotating arm.

10. Apparatus as in claim 1, wherein said fourth axis of rotation is parallel to said first axis of rotation.

11. Apparatus as in claim 1, wherein said cutting unit also comprises a second rotating cutting member, which is mounted rotatable around a third axis of rotation on a second end of said rotating arm, and in that said cutting unit comprises another driven member driven in rotation around another axis of rotation by said motorized member through another motion transmission element, said other driven member being integrally coupled to said second cutting member, wherein said other axis of rotation is disposed so as to coincide with said third axis of rotation.

12. Apparatus as in claim 11, wherein said first and second cutting member are symmetrical with respect to said first axis of rotation so as to have the same orientation with respect to the directrix of feed when they reach the cutting position.

13. Cutting unit for an apparatus for producing tubular products starting from a tubular body, wherein said cutting unit is configured to be disposed along a directrix of feed of said tubular body to be cut and comprises a rotating arm mounted rotating around a first axis of rotation that is inclined by an angle with respect to said directrix of feed and on which there is mounted at least one cutting member provided with a cutting blade to cut said tubular body in a cutting position while said tubular body advances along said directrix of feed and while the rotating arm rotates, said at least one cutting member being driven in rotation by motion transmission means around a second axis of rotation which is inclined with respect to said first axis of rotation, wherein said motion transmission means comprise a motorized member, driven in rotation around a fourth axis of rotation, and a driven member, driven in rotation around a fifth axis of rotation by said motorized member through a motion transmission element, characterized in that said driven member is integrally coupled to said cutting member with the fifth axis of rotation disposed in such a way as to coincide with the second axis of rotation.

14. Apparatus as in claim 10, wherein said fourth axis of rotation is coaxial to said first axis of rotation.
